(19) United States
(12) Patent Application Publication
(10) Pub. No.: US 2007/0145656 A1
(43) Pub. Date: Jun. 28, 2007

(54) SLIPPER END LEAF SPRING HAVING A VARIABLE CROSS SECTION

(76) Inventors: Melvin Svendsen, Calgary (CD); Donald Stoesz, Langdon (CD); Stephen L. Depue, Calgary (CD)

Correspondence Address: ADE & COMPANY INC., 2157 Henderson Highway, WINNIPEG, MB, R2G1P9, CA

(21) Appl. No.: 11/561,482

(22) Filed: Nov. 20, 2006

Related U.S. Application Data
(60) Provisional application No. 60/737,761, filed on Nov. 18, 2005.

(51) Int. Cl. F16F 1/26

(52) U.S. Cl. 267/260

(57) ABSTRACT

A slipper end leaf spring assembly features a main spring having opposite ends portions at which mounting members are disposed. A central portion disposed between the end portions is profiled to provide particular spring characteristics. At least one of the end portions is arranged to at least partially support a respective mounting member through contact with an upper transverse element thereof extending across the main spring thereabove. In order to improve resistance to wear of the end portion due to contact with the upper element, the end portion has a thickness greater than a nearest end of the central portion. This shaping of the spring provides the improved resistance at the end portions without altering the spring characteristics provided by the central portion's thickness profile.

This application claims benefit of United States provisional application 60/737,761 filed Nov. 18, 2005.

This invention relates to leaf springs and more particularly to a leaf spring having at least one slipper end with improved wear resistance.

### BACKGROUND OF THE INVENTION

Leaf springs are typically used to resiliently support one component on another. For example, leaf spring assemblies are often used to connect one or more axles to a frame in vehicle suspension systems. Different types of leaf springs are known to have different mounting elements by which they are supported. This application is concerned with the type of leaf spring having at least one slipper end for mounting on one of the two components it resiliently connects.

Referring to the example of vehicle suspension, a plurality of leaf springs in a stacked arrangement may be connected to a vehicle frame by hangers provided at opposite ends of the springs. A slipper end of the springs is an end that extends in a straight or curved manner into a respective hangar between a pair of horizontal elements. Typically, this pair of hanger elements consists of a transverse pin and a wear pad disposed below and above the springs respectively. Between the frame supported hangars at opposite ends, the springs are connected to an axle of the vehicle, thereby resiliently connecting the frame and axle. Leaf spring slipper suspensions can be used on large commercial trailers for on and/or off highway use, such as logging trailers, where loads can be in the range of 50,000 lbs. Under loading of such magnitude, tremendous wear can occur at the interface between the springs and the hanger.

As a result, there is a desire to increase the durability and reliability of leaf springs having slipper ends in order to increase the level of safety involved in the use of such springs.

### SUMMARY OF THE INVENTION

According to a first aspect of the invention there is provided a slipper end leaf spring assembly comprising:

a main leaf spring comprising a central portion disposed between first and second end portions, said central portion having a predetermined thickness profile for achieving desired spring characteristics; and

first and second mounting members disposed at the first and second end portions of the main leaf spring respectively;

the first mounting member comprising an upper transverse element extending across the main leaf spring above the first end portion thereof such that said first mounting member can be at least partially supported by contact between said first end portion and said upper element;

the first end portion being greater in thickness than an end of the central portion nearest said first end portion to improve resistance to wear of said first end portion due to contact thereof with the upper element of the first mounting member.

Providing end portions of greater thickness allows the desired spring characteristics to be maintained by leaving the thickness profile of the central portion unchanged and only providing extra material at the end portions that experience wear under loading of the mounting members.

Preferably the first end portion of the main leaf spring is generally uniform in thickness.

Preferably the main leaf spring gradually increases in thickness toward the first end portion from the end of the central portion nearest said first end portion.

Preferably the main leaf spring has been roll forged to gradually increase in thickness toward the first end portion from the end of the central portion nearest said first end portion.

Preferably an upper surface of the main leaf spring slopes upward with respect to a bottom surface thereof toward the first end portion from the end of the central portion nearest said first end portion. Providing the increased thickness of the end potions through shaping of the upper surface allows the bottom surface to retain the shape of a conventional leaf spring so that it can fit properly atop other leaf springs for use in a stacked arrangement.

Preferably the upper transverse element of the first mounting member comprises a wear plate.

The first end portion of the main leaf spring may extend generally linearly. Alternatively, the first end portion of the main leaf spring may curve about an axis transverse thereto.

The first mounting member may further comprise a lower transverse element extending across the main leaf spring below the first end portion thereof and the first end portion may comprise an extension portion extending downward on a side of said lower element opposite the second mounting member such that contact between said extension portion and said lower element prevents sliding of said main leaf spring toward the second mounting member, thereby preventing separation of said first end portion and said first mounting member.

According to a second aspect of the invention there is provided a slipper end leaf spring assembly comprising:

a main leaf spring comprising a central portion disposed between first and second end portions, said central portion having a predetermined thickness profile for achieving desired spring characteristics; and

first and second mounting members disposed at the first and second end portions of the main leaf spring respectively, each mounting member comprising an upper transverse element extending across the main leaf spring above the respective end portion thereof such that the mounting members can be at least partially supported by contact between the end portions of the main leaf spring and the upper elements of the mounting members;

the end portions being greater in thickness than ends of the central portion to improve resistance to wear of said end portions due to contact thereof with the upper elements of the mounting members.

According to a third aspect of the invention there is provided a slipper end leaf spring comprising:

first and second end portions; and

a central portion disposed between the first and second end portions and having a predetermined thickness profile for achieving desired spring characteristics;

at least one of the end portions being greater in thickness than a respective end of the central portion nearest said end portion to improve resistance to wear of said end portion.

### BRIEF DESCRIPTION OF THE DRAWINGS

In the accompanying drawings, which illustrate an exemplary embodiment of the present invention:

FIG. 1 is a side view of a leaf spring assembly mounted on a vehicle frame for use in a four spring suspension system.

FIG. 2 is a close up side view of a mounting point of the assembly of FIG. 1.

FIG. 3 is a partial side view of a main leaf spring from the leaf spring assemblies of FIG. 1.

FIG. 4 is a partial side view of a conventional leaf spring.

FIG. 5 is a side view of a leaf spring stack from the assembly of FIG. 1.

### DETAILED DESCRIPTION

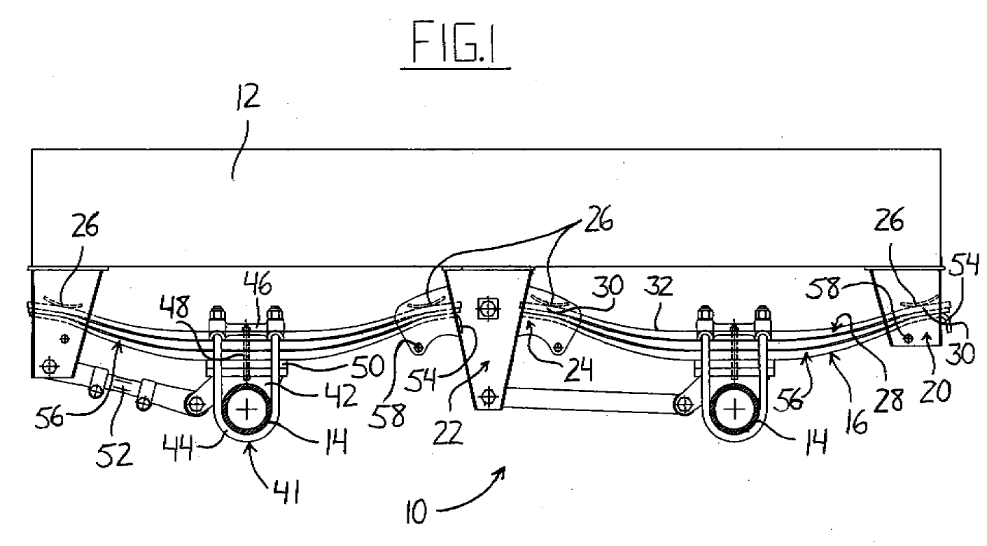

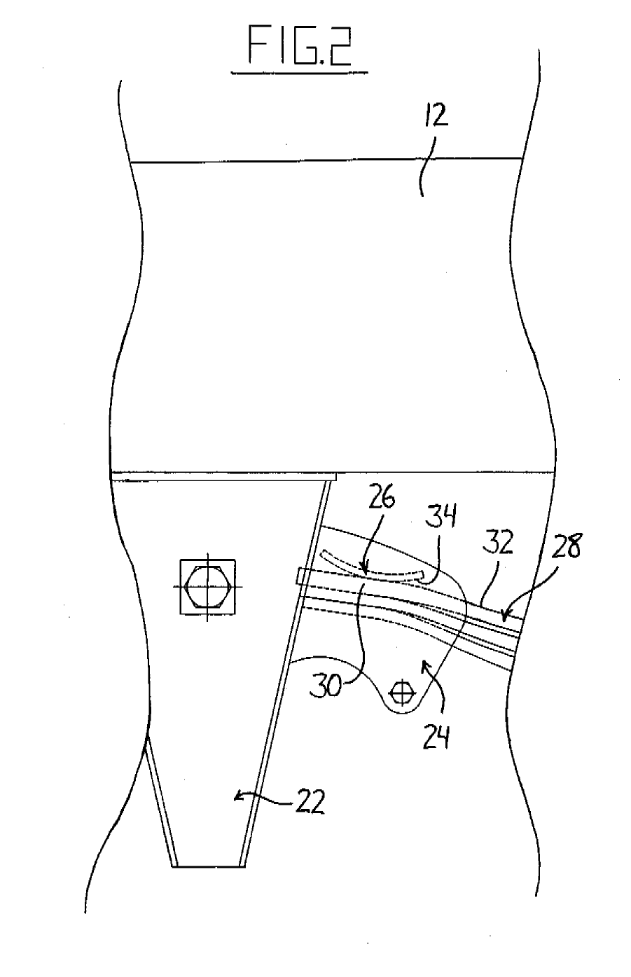

FIG. 1 shows leaf spring assembly 10 mounted on a frame 12 of a vehicle as part of a four spring suspension system used to distribute the vehicle's weight between two separate axles 14. The resilience of the suspension system is provided between the frame 12 and axles 14 by stacks 16 of leaf springs. The leaf spring stacks 16 are each disposed between an end hanger 20 and a center hanger 22, each of which are attached to the frame 12 to extend downward therefrom. An equalizer 24 pivotally supported on the center hanger 22 serves to transfer loading between the leaf spring stacks 16 in order to maintain a desired weight distribution between the axles 14.

Each end of the equalizer 24 and each end hangar 20 is provided with a wear pad 26 extending thereacross. A main spring 28 of each stack 16 bears against its respective wear pads 26 at end portions 30 in order to support the vehicle frame 12 by means of the hangers. Engagement of an upper surface 32 of the main spring 28 with a lower surface 34 of the wear pad 26 defines a slipper type end of the stack 16, as opposed to other end types such as an eye end at which a leaf spring stack is supported by a pin passed through a cylindrical opening defined in the main spring. While each leaf spring stack 16 in the detailed embodiment is shown as having two slipper ends, it should be appreciated that the present invention may be applied to any application in which a stack or individual spring has at least one slipper type end.

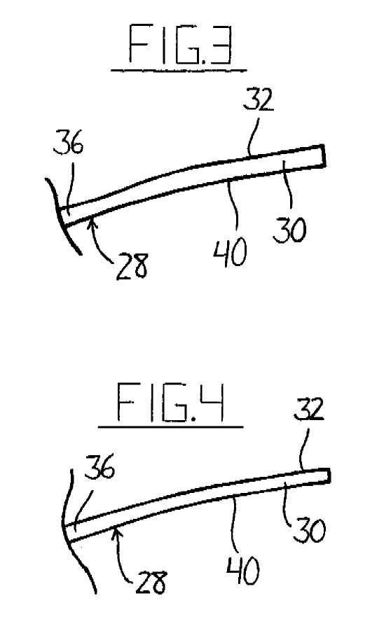

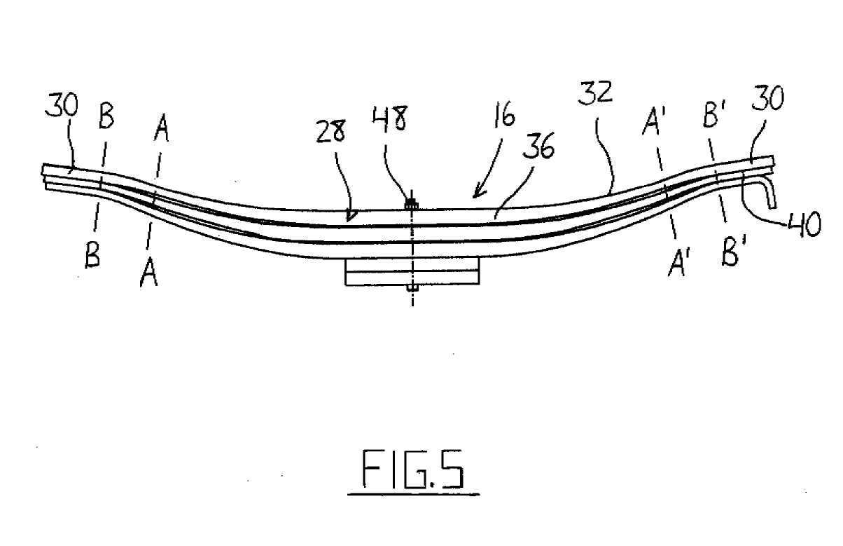

Loading of the vehicle frame 12 causes large amounts of force to be exerted between the main spring 28 and wear pad 26. Coupled with relative movement of the spring stack 16 with respect to the frame 12, these forces cause a high degree of wear at the end portions 30 of the main spring 28 as a result of contact between the engaging surfaces 32 and 34. In order to increase resistance to this wearing, the main spring 28 of the present invention features a thickness at its end portions 30 greater than that of the main spring of a conventional leaf spring assembly. FIGS. 3 and 4 respectively show thickness profiles in the vicinity of end portions 30 of a main spring 28 according to the present invention and conventional teachings. In each case, a central portion 36 of the spring 28 is profiled to achieve desired spring characteristics. In the prior art of FIG. 4, the central portion 36 thins moving distally outward toward an end portion 30 of constant thickness. The main spring of the present invention also has an end portion 30 of constant thickness, except that it is thicker than that of the prior art. The central portion 36 still grows thinner moving distally outward, but the spring 28 increases in thickness between the central portion 36 and end portion 30. The central portion 36 retains the profile necessary for the desired spring characteristics, but the increase thickness of the end portion 30 provides better resistance to wear of the upper surface 32.

Comparing the springs of FIGS. 3 and 4, it should be appreciated that the shape of the bottom surface 40 of the main spring in the present invention is generally unchanged from the prior art. The increased thickness at the end portion 30 is the result of changing the shape of the upper surface 32. Adding material to the top of the spring 28 prolongs the life of the spring by providing extra wear resistance without affecting the way the main spring 28 sits atop the other springs in the stack 16. Changing the spring's profile by adding material to the bottom would alter the shape of the bottom surface 40 and affect the flush engagement of the stacked springs at the end portions 30. The increased thickness at the end portions 30 may be achieved by precision roll forging.

FIG. 5 shows one of the stacks 16 of the leaf spring assembly wherein only the main spring 28 at the top of the stack has its end portions 30 thickened to resist wear, as it is the spring on which the wear pads 26 sit to support the frame 12. The central portion 36 of each spring extends between line A-A and A′-A′ and the uniform thickness end portions 30 of each spring extend outward from lines B-B and B′-B′ to the ends of the stack 16. From this illustration, it should be appreciated that in the main spring 28 of the present invention the end portion 30 has a thickness greater than the nearest end of the central portion 36. This differs from the conventional springs beneath the main spring 28 which are thinner at the end portion than at the nearest end of the central portion. From A-A to B-B and A′-A′ to B′-B′, the upper surface 32 of the main spring 28 slopes upwardly away from the bottom surface 40 to increase the thickness of the spring gradually between the central portion 36 and end portions 30.

The leaf spring assembly 10 features conventional coupling mounts 41 each of which features an axle seat 42 disposed below the spring stack 16 for receiving a respective one of the axles 14, The axle 14 is held in the seat 42 by U-bolts 44 that are engaged thereabout and fastened to a top plate 46 disposed on the top surface 32 of the stack 16. The U-bolts clamp the axle 14 and seat 42 to the stack 16 of springs which are held together by a fastener 48 passing centrally therethrough. The fastener 48 also holds spacer blocks 50 in the stack 16 in order to provide a desired spacing between the axle 14 and the springs. In this arrangement, the axle seat 42 and spring stack 16 are said to be overlsung as they are positioned above the axle 14 and the U-bolts are arranged in a standard configuration about the axle 14. Underslung and inverted U-bolt arrangements are known to those of skill in the art and can be applied to the present invention. A torque arm 52 extends between each axle seat 42 and a respective hangar in order to retain axle alignment and control axle torque.

At the ends at which the hangers and axle seats 42 are not connected by torque arms 52, an extension portion 54 extends downward from the bottom spring 56 of the stack. Each end hanger 20 and each end of the equalizer 24 includes a pin 58 extending thereacross beneath the spring stack 16 such that the respective end portion 30 is received between the wear pad 26, the pin 58 and spaced apart side walls of the hangar or equalizer. The extension portion 54 forms a hook end that will engage the pin 58 to prevent inadvertent withdrawal of the spring stack 16 from the hangar or equalizer. It should be appreciated that extension elements may also be provided at the ends having torque arms 52.

Although the detailed embodiment has been described in the context of a leaf spring assembly 10 for a four spring suspension system, it should be appreciated that a spring 28 having a profile that increases the height of the spring's cross section to provide a thicker slipper portion 30 can be used in a number of applications. Depending on the application, slipper springs may feature flat or curved slipper ends which may or may not have an extension portion to form a hook end. Leaf springs arranged to be supported by an eye at one end and having a sliding slipper arrangement at the other end are often used in suspension systems. Since the thickened slipper end portions 30 of the present invention provides increased wear resistance without modifying the central portion 36 of a conventional leaf spring, they may be applied to springs having tapered or constant cross section central portions. It should be appreciated that a single leaf spring may be used in some applications, in which case if a hook end is desired, then the extension portion 54 would be integral to the single spring. In cases where a stack of springs is used, the extension portion 54 used to create a hook end may not necessarily be part of the bottom spring. For example, in a stack of untapered springs, the overall thickness of the stack is varied along its length by providing a relatively long main spring stacked on and centrally aligned with a series of progressively shorter springs. In this case, the shorter springs may not extend past the pin 58 in order to provide a useful hook end. In the detailed embodiment, the bottom spring 56 features the extension portion 54 because the springs are generally equal in length as they are individually tapered from the center to their opposite ends in order to provide the varying thickness of the stack 16 along its length.

In the figures, each end portion 30 is shown to have uniform thickness and the increase in thickness between the central portion 28 and the end portions 30 is defined by the upper surface 32 of the main spring 28 sloping upwardly away from the bottom surface 40. While this particular shaping provides even wear resistance over the length of the end portion 30 and allows flush stacking of additional springs beneath the mains spring, it should be appreciated that the different profiles may be employed to provide an improved wear zone and that the end portion 30 may vary in thickness over its length.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A slipper end leaf spring assembly comprising.
a main leaf spring comprising a central portion disposed between first and second end portions, said central portion having a predetermined thickness profile for achieving desired spring characteristics; and
first and second mounting members disposed at the first and second end portions of the main leaf spring respectively;
the first mounting member comprising an upper transverse element extending across the main leaf spring above the first end portion thereof such that said first mounting member can be at least partially supported by contact between said first end portion and said upper element;
the first end portion being greater in thickness than an end of the central portion nearest said first end portion to improve resistance to wear of said first end portion due to contact thereof with the upper element of the first mounting member.

2. The leaf spring assembly according to claim 1 wherein the first end portion of the main leaf spring is generally uniform in thickness.

3. The leaf spring assembly according to claim 1 wherein the main leaf spring gradually increases in thickness toward the first end portion from the end of the central portion nearest said first end portion.

4. The leaf spring assembly according to claim 1 wherein the main leaf spring has been roll forged to gradually increase in thickness toward the first end portion from the end of the central portion nearest said first end portion.

5. The leaf spring assembly according to claim 1 wherein an upper surface of the main leaf spring slopes upward with respect to a bottom surface thereof toward the first end portion from the end of the central portion nearest said first end portion.

6. The leaf spring assembly according to claim 1 wherein the upper transverse element of the first mounting member comprises a wear plate.

7. The leaf spring assembly according to claim 1 wherein the first end portion of the main leaf spring extends generally linearly.

8. The leaf spring assembly according to claim 1 wherein the first end portion of the main leaf spring curves about an axis transverse thereto.

9. The leaf spring assembly according to claim 1 wherein the first mounting member further comprises a lower transverse element extending across the main leaf spring below the first end portion thereof and wherein said first end portion comprises an extension portion extending downward on a side of said lower element opposite the second mounting member such that contact between said extension portion and said lower element prevents sliding of said main leaf spring toward the second mounting member, thereby preventing separation of said first end portion and said first mounting member.

10. A slipper end leaf spring assembly comprising:
a main leaf spring comprising a central portion disposed between first and second end portions, said central portion having a predetermined thickness profile for achieving desired spring characteristics; and
first and second mounting members disposed at the first and second end portions of the main leaf spring respectively each mounting member comprising an upper transverse element extending across the main leaf spring above the respective end portion thereof such that the mounting members can be at least partially supported by contact between the end portions of the main leaf spring and the upper elements of the mounting members;
the end portions being greater in thickness than ends of the central portion to improve resistance to wear of said end portions due to contact thereof with the upper elements of the mounting members.

11. The leaf spring assembly according to claim 10 wherein each end portion of the main leaf spring is generally uniform in thickness.

12. The leaf spring assembly according to claim 10 wherein the main leaf spring gradually increases in thickness toward the end portions from the ends of the central portion.

13. The leaf spring assembly according to claim 10 wherein the main leaf spring has been roll forged to gradually increase in thickness toward the end portions from the ends of the central portion.

14. The leaf spring assembly according to claim 10 wherein an upper surface of the main leaf spring slopes upward with respect to a bottom surface thereof toward the end portions from the ends of the central portion.

15. The leaf spring assembly according to claim 10 wherein the upper transverse element of each mounting member comprises a wear plate.

16. The leaf spring assembly according to claim 10 wherein the end portions of the main leaf spring extends generally linearly.

17. The leaf spring assembly according to claim 10 wherein each end portion of the main leaf spring curves about an axis transverse thereto.

18. The leaf spring assembly according to claim 10 wherein at least one mounting member further comprises a lower transverse element extending across the main leaf spring below the respective end portion thereof and wherein said respective end portion comprises an extension portion extending downward on a side of said lower element opposite the central portion of said main leaf spring such that contact between said extension portion and said lower element prevents sliding of said main leaf spring toward an opposite mounting member, thereby preventing separation of said respective end portion and said at least one mounting member.

19. A slipper end leaf spring comprising:
first and second end portions; and
a central portion disposed between the first and second end portions and having a predetermined thickness profile for achieving desired spring characteristics;
at least one of the end portions being greater in thickness than an end of the central portion nearest said end portion to improve resistance to wear of said end portion.

20. The leaf spring according to claim 19 wherein said leaf spring gradually increases in thickness toward the at least one end portion from the end of the central portion nearest said end portion.
